(19) United States
(12) Patent Application Publication
(10) Pub. No.: US 2021/0029995 A1
(43) Pub. Date: Feb. 4, 2021

(54) Use of Volatile Organic Compounds as Pesticides

(71) Applicant: Certis Europe B.V., Swansea (NL)

(72) Inventors: Tariq Butt, Swansea (GB); Esam Hummadi, Swansea (GB)

(21) Appl. No.: 17/042,541

(22) PCT Filed: Sep. 28, 2019
(86) PCT No.: PCT/EP2019/057911

§ 371 Date: Sep. 28, 2020

(30) Foreign Application Priority Data
Mar. 28, 2018 (GB) 1805053.4

(51) Int. Cl. A01N 37/12

(52) U.S. Cl. CPC A01N 37/12

(57) ABSTRACT

The present invention relates to the use of 1-octen-3-ol, 3-octanone, isoamyl formate, or a mixture thereof, as a nematicide.

The present invention relates to nematicides, in particular to the use of 1-octen-3-ol, 3-octanone, isoamyl formate, or a mixture thereof, as a nematicide.

### BACKGROUND

Plant-parasitic nematodes are widely recognised as major agricultural pests which cause significant crop losses and place a costly burden on agricultural crop production. There are thousands of species of plant-parasitic nematodes which together cause billions of dollars' worth of damage to crops each year.

One commonly used method for eliminating plant-parasitic nematodes is fumigation. Fumigants are widely used for the disinfestation, and protection against infestation, that is required to protect crops, stored produce, timbers and enclosed spaces. However, because of the need for high volatility of the compounds employed as fumigants, only a small number of chemicals are routinely used. These suffer from a range of drawbacks including high toxicity to humans and to non-target animals, rendering their use hazardous, and adverse environmental impact. For example, methyl bromide was among the most widely used fumigants until its production and use was restricted by the Montreal Protocol due to its role in ozone depletion.

### SUMMARY OF INVENTION

Viewed from a first aspect, the present invention provides the use of 3-octanone, 1-octen-3-ol, isoamyl formate, or a mixture thereof, as a nematicide.

Viewed from a further aspect, the present invention provides a method of controlling nematodes, comprising applying an effective amount of 3-octanone, 1-octen-3-ol, isoamyl formate, or a mixture thereof, to an area requiring nematode control.

### Definitions

As used herein, the term “pesticide” refers to any natural, synthetic or semi-synthetic substance that may be used to control (e.g. inhibit the growth of, repel and/or kill) unwanted organisms (pests) such as plants, insects, animals, fungi, molluscs, arthropods, larvae, nematodes, microorganisms and algae.

As used herein, the term “nematicide” refers to a pesticide that may be used to control nematodes.

As used herein, the term “antimicrobial” refers to a pesticide that may be used to control (e.g. inhibit the growth of, repel and/or kill) one or more microorganisms (e.g. bacteria, fungi, or viruses).

As used herein, the term “active ingredient” refers to any compound which is biologically active in the target organisms.

As used herein, the term “fumigant” refers to a pesticide, or a composition comprising a pesticide, which exists in gaseous form when it is used to control pests.

As used herein, the term “fumigation” refers to a method of pest control that uses a gaseous pesticide to control pests.

As used herein, the term “volatile organic compound” (“VOC”) refers to an organic chemical compound (i.e. a compound containing carbon and hydrogen atoms and optionally containing heteroatoms such as oxygen, sulphur, halogens and nitrogen) whose composition makes it possible for them to easily evaporate under normal atmospheric conditions of temperature and pressure. VOCs are generally low molecular weight compounds.

As used herein, the term “composition” refers to an administrable or useable form. Compositions often include additional ingredients other than the active ingredients, e.g. pesticide, to improve the properties of the composition e.g. to make the composition more stable and/or easier to handle, store and/or apply. The compositions described herein may be “solid”, “liquid” or “slurry” compositions. “Solid” compositions are compositions that are solid (i.e. not liquid or gaseous) at 20° C. and atmospheric pressure. “Liquid” compositions are compositions that are liquid (i.e. not solid or gaseous) at 20° C. and atmospheric pressure. “Slurry” compositions are fluid mixtures of a solid with a liquid at 20° C. and atmospheric pressure.

### DESCRIPTION OF INVENTION

The present invention provides the use of 1-octen-3-ol, 3-octanone, isoamyl formate, or a mixture thereof, as a nematicide. 1-Octen-3-ol, 3-octanone and isoamyl formate are volatile organic compound (VOC) natural products produced by the entomopathogenic fungus Metarhizium brunneum. The compounds each exhibit promising nematicidal activity. Advantageously they are much safer, with a better environmental profile, than many current commercial nematicides. The compounds are often used as flavour or fragrance ingredients. For example, 1-octen-3-ol is approved by the US Food and Drug administration as a food additive. 1-Octen-3-ol, 3-octanone and isoamyl formate also exhibit high volatility, making them particularly suitable for use as fumigants. Moreover, 1-octen-3-ol, 3-octanone and isoamyl formate are each commercially available and thus are readily accessible and relatively inexpensive.

In some preferred uses of the present invention, 1-octen-3-ol is used as the nematicide. In other preferred uses of the present invention, 3-octanone is used as the nematicide. In other preferred uses of the present invention, isoamyl formate is used as the nematicide. Alternatively, two or more of 1-octen-3-ol, 3-octanone, and isoamyl formate are used as the nematicide, for example in admixture. The two or more of 1-octen-3-ol, 3-octanone, and isoamyl formate may be used separately, sequentially and/or in combination with each other, e.g. as a mixture. Thus in some preferred uses the present invention provides the use of 1-octen-3-ol and 3-octanone as a nematicide. In other preferred uses the present invention provides the use of 1-octen-3-ol and isoamyl formate as a nematicide. In other preferred uses the present invention provides the use of 3-octanone and isoamyl formate as a nematicide.

In some uses of the present invention, a further active ingredient is used. Thus the invention preferably provides the use of 1-octen-3-ol, 3-octanone, isoamyl formate, or a mixture thereof, as a nematicide, wherein the 1-octen-3-ol, 3-octanone, isoamyl formate or mixture thereof is used separately, sequentially and/or in combination with a further active ingredient. One further active ingredient may be used, or multiple further active ingredients may be used. The further active ingredient is preferably a pesticide.

Preferred antimicrobials for use in the present invention are selected from dimethyl disulfoxide, dimethyl disulfide, barium polysulfide, calcium polysulfide, potassium polysulfide, sodium polysulfide, carbon disulphide, cyanogen, chloropicrin, methyl bromide, methyl iodide, sodium tetrathiocarbonate, dichloropropene and mixtures thereof, preferably dimethyl disulfoxide, dimethyl disulfide, barium polysulfide, calcium polysulfide, potassium polysulfide, sodium polysulfide and mixtures thereof. However, in some preferred uses, no further active ingredient which is an antimicrobial is used.

Preferably, the further active ingredient is a pesticide. Thus the invention preferably provides the use of 1-octen-3-ol, 3-octanone, isoamyl formate, or a mixture thereof, as a nematicide, wherein the 1-octen-3-ol, 3-octanone, isoamyl formate or mixture thereof is used separately, sequentially and/or in combination with a further pesticide. The 1-octen-3-ol, 3-octanone, isoamyl formate or mixture thereof may be used separately, sequentially and/or in combination with multiple (e.g. 2, 3 or 4) further pesticides. Preferably, the further pesticide is selected from herbicides, molluscicides, insecticides, fungicides, algaecides, rodenticides, nematicides, acaricides, larvicides and mixtures thereof. In some preferred uses of the invention, the further pesticide is a pesticide other than a nematicide. This enables the control of multiple different kinds of pest in a single process, with the 1-octen-3-ol, 3-octanone, isoamyl formate or mixture thereof providing sufficient nematode control and the further pesticide(s) providing complementary control of one or more different kinds of pest.

Preferred molluscicides for use in the present invention are selected from metaldehyde, copper sulfate, kainite, phenol pentabromide, sodium pentachlorophenolate, 2,4,6-triiodophenol, 2,4,6-tribromophenol, niclosamide, copper dimethyl dithiocarbamate, 2,4-dinitro creosol, allicin, bromoacetamide, calcium arsenate, cloethocarb, fentin, ferric phosphate, methiocarb, niclosamide, Paris green, pentachlorophenol, sodium pentachlorophenate, tazimcarb, thiacloprid, thiodicarb, tralopyril, tributyltin oxide, trifenmorph, trimethacarb and mixtures thereof, preferably metaldehyde.

Preferred herbicides for use in the present invention may be selected from isoproturon, norflurazon, fluridone, paraquat, simazine, glyphosphate, terbuthylazine, cyhalofop-butyl, penoxsulam, bensulfuron-methyl, azimsulfuron, imazosulfuron, fenoxaprop-P-ethyl, 2,4-D, acetochlor, acifluorfen, alachlor, amidosulfuron, aminopyralid, aminotriazole, ammonium thiocyanate, anilifos, benfuresate, bentazon, benthiocarb, benzobicyclon, benzofenap, bifenox, bromobutide, butachlor, cafenstrole, carfentrazone, chlorimuron, chlorpropham, clomazone, clomeprop, clopyralid, cumyluron, daimuron, diclofop, diflufenican, dimepiperate, dimethametryn, diquat, dithiopyr, EK2612, EPTC, esprocarb, ET-751, ethbenzanid, fenoxaprop-ethyl, isoxidifen-ethyl, fenoxasulfone, fentrazamide, flazasulfuron, flufenacet, flufenpyr, flumioxazin, flupyrsulfuron, fluroxypyr, fomesafen, foramsulfuron, glufosinate, glyphosate, imazamethabenz, imazapic, imazapyr, imazaquin, indanofan, indaziflam, ioxynil, ipfencarbazone, isoxaben, MCPA, MCPB, mefenacet, mesosulfuron, mesotrione, metolachlor, molinate, monosulfuron, MSMA, orthosulfamuron, oryzalin, oxadiargyl, oxadiazon, oxazichlomefone, oxyfluorfen, paraquat, pendimethalin, pentoxazone, pethoxamid, picloram, pinoxaden, piperophos, pretilachlor, prohexadione, propachlor, propanil, propisochlor, propyzamide, prosulfocarb, prosulfuron, pyributicarb, pyraclonil, pyrazogyl, pyrazolynate, pyrazoxyfen, pyridate, quinoclamine, quinclorac, S-3252, saflufenacil, simazine, simetryne, s-metolachlor, sulcotrione, sulfentrazone, sulfosate, tefuryltrione, tepraloxydim, thenylchlor, thiazopyr, thiobencarb, triclopyr, trifluralin, trinexapac, tritosulfuron and mixtures thereof, preferably isoproturon, norflurazon, fluridone, paraquat and simazine.

Preferred insecticides for use in the present invention may be selected from chlorpyrifos, carbofuran, fibronil, abamectin, acephate, acetamiprid, acrinathrin, cypermethrin, endosulfan, azadirachtin, azinphos-ethyl, azinphos-methyl, bendiocarb, benfuracarb, bensultap, cyfluthrin, cypermethrin, bifenthrin, bufencarb, buprofezin, butacarb, cadusafos, carbaryl, carbofuran, carbosulfan, cartap, cartap hydrochloride, chlorantraniliprole, chlorfenapyr, chlorfenvinphos, chlorfluazuron, chlormephos, chlorpyrifos, chlorpyrifos-methyl, chromafenozide, clothianidin, cyantraniliprole, cyfluthrin, cyhalothrin, cypermethrin, deltamethrin, diazinon, dicrotophos, diflubenzuron, dimethoate dinotefuran, disulfoton, emamectin, emamectin benzoate, endosulfan, endothion, endrin, EPN, esfenvalerate, etaphos, ethiofencarb, ethion, ethiprole, ethoate-methyl, etofenprox, fenamiphos, fenazafior, fenethacarb, fenitrothion, fenobucarb, fenpropathrin, fensulfothion, fenthion, fenthion-ethyl, fenvalerate, fipronil, flonicamid, flubendiamide, flucythrinate, fonofos, fufenozide, furathiocarb, gamma-cyhalothrin, gamma-RCR, halfenprox, halofenozide, heptenophos, hyquincarb, imidacloprid, indoxacarb, isazofos, isobenzan, isocarbophos, isofenphos, isofenphos-methyl, isoprocarb, isothioate, isoxathion, kinoprene, cyhalothrin, lepimectin, lufenuron, malathion, methamidophos, methomyl, methoxyfenozide, mevinphos, mexacarbate, milbemectin, monocrotophos, nitenpyram, novaluron, omethoate, oxamyl, oxydemeton-methyl, oxydeprofos, oxydisulfoton, parathion, parathion-methyl, penfluron, permethrin, phenthoate, phorate, phosalone, phosfolan, phosmet, phosphamidon, pirimetaphos, pirimicarb, pirimiphos-ethyl, pirimiphos-methyl, primidophos, profenofos, profluthrin, promecarb, propaphos, propoxur, prothiofos, pymetrozine, pyrafluprole, pyridalyl, pyrifluquinazon, pyriprole, pyriproxyfen, spinetoram, spinosad, spirotetramat, sulfoxaflor, sulprofos, tau-fluvalinate, tebufenozide, tebufenpyrad, teflubenzuron, tefluthrin, tetramethylfluthrin, theta-cypermethrin, thiacloprid, thiamethoxam, thicrofos, thiocyclam, thiocyclam oxalate, thiodicarb, thiometon, thiosultap, thiosultap-disodium, thiosultap-monosodium, thuringiensin, tolfenpyrad, triazophos, triflumuron, zeta-cypermethrin and mixtures thereof, preferably chlorpyrifos, carbofuran and fibronil.

Preferred fungicides for use in the present invention may be selected from tricyclazole, phthalide, carpropamide, pyroquilon, diclocymet, fenoxanil, probenazole, isoprothiolane, iprobenfos, isotianil, tiadinil, kasugamycin, flutolanil, mepronil, pencycuron, polyoxins, validamycin, toclophos-methyl, boscalid, penthiopyrad, thifluzamide, bixafen, fluopyram, isopyrazam, propiconazole, difenoconazole, fenbuconazole, ipconazole, triadimefon, hexaconazole, azoxystrobin, metaminostrobin, orysastrobin, acibenzolar-S-methyl and mixtures thereof.

Preferred algaecides for use in the present invention may be selected from benzalkonium chloride, bethoxazin, copper sulfate, cybutryne, dichlone, dichlorophen, diuron, endothal, fentin, hydrated lime, isoproturon, methabenzthiazuron, nabam, oxyfluorfen, pentachlorophenyl laurate, quinoclamine, quinonamid, simazine terbutryn and mixtures thereof.

Preferred rodenticides for use in the present invention may be selected from warfarin, chlorphacinone, diphacinone, bromadiolone, difethialone, brodifacoum, bromethalin, cholecalciferol, zinc phosphide, strychnine and mixtures thereof.

Preferred acaricides for use in the present invention may be selected from permethrin, ivermectin, dicofol, abamectin, acequinocyl, bifenazate, chlorpenafyr, clofentezine, cyflumetofen, cypermethrin, dicofol, etoxazole, fenazaquin, fenpyroximate, hexythiazox, imidacloprid, propargite, pyridaben, spiromesifen, spirotetramat and mixtures thereof.

Preferred larvicides for use in the present invention may be selected from bifenthrin, carbofuran, chlorpyrifos, cyfluthrin, phostebupirim, diazinon, ethoprop, fipronil, imidacloprid, lindane, permethrin, phorate, terbufos, captan, carboxin, maneb, metalaxyl, thiamethoxam and mixtures thereof.

In other preferred uses of the invention, the further pesticide is a further nematicide (i.e. a nematicide other than 1-octen-3-ol, 3-octanone, isoamyl formate, or a mixture thereof). Thus preferably the present invention provides the use of 1-octen-3-ol, 3-octanone, isoamyl formate, or a mixture thereof, as a nematicide, wherein the 1-octen-3-ol, 3-octanone, isoamyl formate or mixture thereof is used separately, sequentially and/or in combination with a further nematicide. The use of a further nematicide may advantageously contribute to a higher level of nematode control or a longer lasting nematicidal effect. It may, for example, be beneficial to employ a further nematicide having a lower volatility than the 1-octen-3-ol, 3-octanone, isoamyl formate, or a mixture thereof, or having other complementary properties. The further nematicide is preferably selected from methyl bromide, 1,3-dichloropropene, ethylene dibromide, metam-sodium, dazomet, methyl isothiocyanate, chloropicrin, thionazin, ethoprophos, fenamiphos, fensulfothion, terbufos, isazofos, ebufos, aldicarb, aldoxycarb, oxamyl, carbofuran, cleothocarb and mixtures thereof.

In some preferred uses of the present invention, however, no further (i.e. no additional) nematicides are used, i.e. no nematicide other than the 1-octen-3-ol, 3-octanone, isoamyl formate, or mixture thereof, is used. This advantageously avoids the use of substances which may have harmful effects, e.g. in terms of toxicity and/or environmental impact, or may be difficult or expensive to obtain or use. The use is also simpler as complex combinations, applications and sequences of various nematicides are avoided, whilst still achieving the desired nematicidal effect. In such uses the nematicidal effect is thus achieved solely by the 1-octen-3-ol, 3-octanone, isoamyl formate, or mixture thereof, which have the desirable properties described above. Thus in a preferred use the invention provides the use of 1-octen-3-ol, 3-octanone, isoamyl formate, or a mixture thereof, as a nematicide, wherein no further nematicides are used. Thus the invention preferably provides the use of 1-octen-3-ol, 3-octanone, isoamyl formate, or a mixture thereof, as a nematicide, wherein the 1-octen-3-ol, 3-octanone, isoamyl formate, or mixture thereof is the sole nematicide.

Particularly preferably, no further (i.e. no additional) pesticides are used in the present invention, i.e. no pesticide other than the 1-octen-3-ol, 3-octanone, isoamyl formate, or mixture thereof, is used. In such uses the pesticidal effect is thus achieved solely by the 1-octen-3-ol, 3-octanone, isoamyl formate, or mixture thereof, which have the desirable properties described above and undesirable effects of further pesticides are avoided. The use is also simpler as complex combinations, applications and sequences of various pesticides are avoided, whilst still achieving the desired nematicidal effect. Thus in a preferred use the invention provides the use of 1-octen-3-ol, 3-octanone, isoamyl formate, or a mixture thereof, as a nematicide, wherein no further pesticides are used. Thus the invention preferably provides the use of 1-octen-3-ol, 3-octanone, isoamyl formate, or a mixture thereof, as a nematicide, wherein the 1-octen-3-ol, 3-octanone, isoamyl formate, or mixture thereof is the sole pesticide.

Especially preferably, no further (i.e. no additional) active ingredients are used in the present invention, i.e. no active ingredient other than the 1-octen-3-ol, 3-octanone, isoamyl formate, or mixture thereof, is used. In such uses the active effect is thus achieved solely by the 1-octen-3-ol, 3-octanone, isoamyl formate, or mixture thereof, which have the desirable properties described above and undesirable effects of further active ingredients are avoided. The use is also simpler as complex combinations, applications and sequences of various active ingredients are avoided, whilst still achieving the desired nematicidal effect. Thus in a preferred use the invention provides the use of 1-octen-3-ol, 3-octanone, isoamyl formate, or a mixture thereof, as a nematicide, wherein no further active ingredients are used. Thus the invention preferably provides the use of 1-octen-3-ol, 3-octanone, isoamyl formate, or a mixture thereof, as a nematicide, wherein the 1-octen-3-ol, 3-octanone, isoamyl formate, or mixture thereof is the sole active ingredient.

In some preferred uses of the present invention, no further (i.e. no additional) volatile organic compounds (VOCs) are used, i.e. no VOC other than the 1-octen-3-ol, 3-octanone, isoamyl formate, or mixture thereof, is used. Thus in a preferred use the invention provides the use of 1-octen-3-ol, 3-octanone, isoamyl formate, or a mixture thereof, as a nematicide, wherein no further volatile organic compounds are used. Thus the invention preferably provides the use of 1-octen-3-ol, 3-octanone, isoamyl formate, or a mixture thereof, as a nematicide, wherein the 1-octen-3-ol, 3-octanone, isoamyl formate, or mixture thereof is the sole volatile organic compound.

In particularly preferred uses of the present invention, the 1-octen-3-ol, 3-octanone, isoamyl formate, or mixture thereof is used in the form of a composition. Especially preferably the composition further comprises one or more additional ingredients. The one or more additional ingredients may comprise one or more of the further active ingredients described above (e.g. one or more of the further antimicrobials, one or more of the further pesticides and/or one or more of the further nematicides). Additionally or alternatively, the one or more additional ingredients may comprise one or more non-active ingredients. These ingredients are conventionally present in pesticidal compositions. The one or more additional ingredients may be selected from bulking agents, bait substances, antifoaming agents, buffers, pH modifiers, antioxidants, biostimulants, preservatives (e.g. mould inhibitors), binding agents, bird deterrents (e.g. dyes), lubricants, animal repellents, carriers, diluents, surfactants, disintegrants, wetting agents and mixtures thereof. Preferably the one or more additional ingredients are selected from carriers, diluents and/or surfactants.

Thus in a preferred use of the present invention, the 1-octen-3-ol, 3-octanone, isoamyl formate, or mixture thereof is used in the form of a composition, wherein the composition further comprises a carrier, a diluent and/or a surfactant. In some uses, the additional ingredient is preferably a carrier, i.e. the composition further comprises a carrier. Any conventional carrier may be used. The carrier may be selected from starch, diatomaceous earth, silica, attapulgite, montmorillonite, kaolin, talc, calcium carbonate (e.g. calcite), corn cob grits, clay, ground nut shells and mixtures thereof. In some uses, the additional ingredient is preferably a diluent, i.e. the composition further comprises a diluent. Any conventional diluent may be used. The diluent may preferably be selected from water, organic solvents, oil-based solvents and mixtures thereof. In some uses, the additional ingredient is preferably a surfactant, i.e. the composition further comprises a surfactant. Any conventional surfactant may be used. The surfactant may be selected from anionic surfactants, cationic surfactants, zwitterionic surfactants, non-ionic surfactants and mixtures thereof. The composition may further comprise bulking agents, bait substances, antifoaming agents, buffers, pH modifiers, biostimulants, preservatives (e.g. mould inhibitors), binding agents, bird deterrents (e.g. dyes), lubricants, animal repellents, disintegrants, wetting agents and mixtures thereof. Any conventional bulking agents, bait substances, antifoaming agents, buffers, pH modifiers, biostimulants, preservatives (e.g. mould inhibitors), binding agents, bird deterrents (e.g. dyes), lubricants, animal repellents, disintegrants, wetting agents may be used.

In uses of the present invention, wherein the 1-octen-3-ol, 3-octanone, isoamyl formate, or mixture thereof is used in the form of a composition, the composition may take any conventional form. Preferably the composition is selected from a solid composition, a liquid composition and a slurry composition. In one preferred use of the present invention, the composition is a solid composition. The solid composition is preferably in the form of pellets, granules (e.g. emulsifiable granules, water dispersible granules or granules for broadcast application), powders (e.g. wettable powders, soluble powders), briquettes, blocks, dusts or mixtures thereof. In another preferred use, the composition is a liquid composition. The liquid composition is preferably in the form of a solution, an emulsion, an emulsifiable concentrate, a suspension or an ultra-low volume concentrate. In a further preferred use, the composition is a slurry composition. In a particularly preferred use, the composition is a slurry composition and the slurry composition is applied to seeds, e.g. as a seed coating. In a preferred use, the composition comprises 1-octen-3-ol, 3-octanone, isoamyl formate, or mixture thereof in encapsulated form.

In especially preferred uses of the present invention, the 1-octen-3-ol, 3-octanone, isoamyl formate, or mixture thereof is a nematicide in a fumigant. Advantageously 1-octen-3-ol, 3-octanone, isoamyl formate, or mixtures thereof are particularly suited to use as nematicides in fumigants due to their high volatility.

Preferably the present invention provides the use of 1-octen-3-ol, 3-octanone, isoamyl formate, or a mixture thereof, as a nematicide to control any type of nematodes. However, in particularly preferred uses, the present invention provides the use of 1-octen-3-ol, 3-octanone, isoamyl formate, or a mixture thereof, as a nematicide to control plant parasitic nematodes. Preferably, the plant parasitic nematode is selected from ectoparasitic nematodes, semi-endoparasitic nematodes (e.g. reniform nematodes, citrus nematodes), migratory endoparasitic nematodes (e.g. lesion nematodes, burrowing nematodes and rice root nematodes), sedentary endoparasitic nematodes (e.g. root knot nematodes and cyst nematodes), stem and bulb nematodes (e.g. Ditylenchus spp.), seed gall nematodes (e.g. Anguina spp.), foliar nematodes, pine wood nematodes (e.g. Bursaphelenchus xylophilus) and mixtures thereof, and particularly preferably, from sedentary endoparasitic nematodes.

In a particularly preferred use, the present invention provides the use of 1-octen-3-ol, 3-octanone, isoamyl formate, or a mixture thereof, as a nematicide to control plant parasitic nematodes selected from cyst nematodes (e.g. Heterodera spp. and Globodera spp.), root knot nematodes (e.g. Meloidogyne spp.), lesion nematodes (e.g. Pratylenchus spp.), burrowing nematodes (e.g. Radopholus similis) and mixtures thereof.

Examples of preferred cyst nematodes that may be controlled by the use of the present invention include soybean cyst nematodes (e.g. Heterodera glycines), cereal cyst nematodes (e.g. Heterodera avenae, H. filipjevi and H. zeae) and potato cyst nematodes (e.g. Globodera rostochiensis and G. pallida). Examples of preferred root knot nematodes that may be controlled by the use of the present invention include Meloidogyne javanica, Meloidogyne arenaria, Meloidogyne hapla, and Meloidogyne incognita. Examples of preferred lesion nematodes that may be controlled by the use of the present invention include P. thornei.

Preferably the present invention provides the use of 1-octen-3-ol, 3-octanone, isoamyl formate, or a mixture thereof, as a nematicide to treat any area, surface, space or entity requiring nematode control. Preferably, however, the present invention provides the use of 1-octen-3-ol, 3-octanone, isoamyl formate, or a mixture thereof, as a nematicide to treat soil, seeds, bulbs, crops, tubers, trees, stored produce or timber. The use may be preventative, treating or a combination thereof.

In one preferred use the present invention provides the use of 1-octen-3-ol, 3-octanone, isoamyl formate, or a mixture thereof as a nematicide to treat soil. Another preferred use is to treat seeds. Preferably the seeds are selected from seeds of any cereal or grain crops (e.g. barley, wheat, oat, triticale, maize, rice, rye, adlay millet, sorghum, millet, teff, fonio or spelt seeds), seeds of any leguminous crops (e.g. pea, chickpea, common bean, soybean, cowpea, lentil, alfalfa, peanut, mung bean or groundnut seeds), seeds of any vegetable crops (e.g. family Solanaceae, Brassicaceae, Allium family, cucurbit family, carrot or lettuce seeds) and seeds of any ornamental flowering crops (e.g. chrysanthemum, carnation or rose seeds). A further preferred use is to treat crops. Preferably the crops are selected from potatoes, sweet potatoes, grain, cereals, fruits, vegetables, pulses, legumes, brassicas, beets (e.g. sugar beets) and ornamental flowering crops. Certain preferred crops include any cereal or grain crops (e.g. barley, wheat, oats, triticale, maize, rice, rye, adlay millet, sorghum, millet, teff, fonio or spelt), any leguminous crops (e.g. pea, chickpea, common bean, soybean, cowpea, lentil, alfalfa, peanut, mung bean or groundnut), any vegetable crops (e.g. family Solanaceae, Brassicaceae, Allium family, cucurbit family, carrot or lettuce) and any ornamental flowering crops (e.g. chrysanthemum, carnation or rose). Especially preferred crops are selected from potatoes, sweet potatoes, brassicas, beets and grains, more preferably from potatoes and grain. Grains of particular interest are cereal grains, such as wheat, rice, maize, barley and oats, preferably wheat, rice and maize. Especially preferably, the present invention is used to treat potatoes.

In one particularly preferred use the present invention provides the use of 1-octen-3-ol, 3-octanone, isoamyl formate, or a mixture thereof as a nematicide to treat stored produce. Preferably the stored produce is selected from potatoes, sweet potatoes, grain, fruits, vegetables, pulses, brassicas, beets (e.g. sugar beets) and cocoa. The stored produce may be unprocessed (e.g. potatoes, sweet potatoes, grain, fruits, vegetables, pulses, brassicas, beets) or processed (e.g. cocoa). Especially preferred stored produce is selected from potatoes, sweet potatoes, brassicas, beets and grains, more preferably from potatoes and grain. Grains of particular interest are cereal grains, such as wheat, rice, maize, barley and oats, preferably wheat, rice and maize. Especially preferably, the present invention is used to treat potatoes (e.g. in potato storage warehouses).

Another preferred use of the present invention is the use of 1-octen-3-ol, 3-octanone, isoamyl formate, or a mixture thereof as a nematicide to treat timber.

The present invention as hereinbefore described may be employed in any space requiring nematode control. The invention may be used outdoors or indoors, in open or enclosed spaces. The present invention preferably provides the use as hereinbefore described in a field, glasshouse, cloche, polytunnel, grain bin, silo, shipping container, warehouse (e.g. a potato or grain storage warehouse, preferably a potato storage warehouse), barn or controlled environment room.

In the use as hereinbefore described, the 1-octen-3-ol, 3-octanone, isoamyl formate, or mixture thereof may be applied to an area to be treated. The 1-octen-3-ol, 3-octanone, isoamyl formate, or mixture thereof may be applied to an area to be treated using any conventional application process. Preferably, the 1-octen-3-ol, 3-octanone, isoamyl formate, or mixture thereof is applied to an area to be treated by band application, basal application, broadcast application, crack and crevice application, directed-spray application, foliar application, soil application, soil incorporation, soil injection, rope-wick treatment, wiper treatment, space treatment, spot treatment, tree injection, spraying and/or fumigation. Application by soil injection, spraying and/or fumigation is particularly preferred.

In a particularly preferred use, the 1-octen-3-ol, 3-octanone, isoamyl formate, or mixture thereof is applied by soil injection, e.g. at high pressure. In another particularly preferred use, the 1-octen-3-ol, 3-octanone, isoamyl formate, or mixture thereof is applied by spraying, e.g. by spraying onto crops.

In another particularly preferred use, the 1-octen-3-ol, 3-octanone, isoamyl formate, or mixture thereof is applied by fumigation. Thus a preferred use of the present invention is 1-octen-3-ol, 3-octanone, isoamyl formate, or a mixture thereof as a nematicide in a fumigation process. The use in a fumigation process is particularly preferred in the treatment of soil and/or in enclosed spaces (e.g. in a glasshouse, cloche, polytunnel, grain bin, silo, shipping container, warehouse (e.g. a potato or grain storage warehouse, preferably a potato storage warehouse), barn or controlled environment room). The use in a fumigation process is especially preferred in the treatment of soil. The use in a fumigation process is especially preferred in a warehouse (e.g. a grain or potato storage warehouse, preferably a potato storage warehouse). The use in a fumigation process is especially preferred in the treatment of stored produce. In such a case the fumigation process may be carried out in a storage facility (e.g. in a glasshouse, cloche, polytunnel, grain bin, silo, shipping container, warehouse (e.g. a potato or grain storage warehouse, preferably a potato storage warehouse), barn or controlled environment room) before the produce is placed in the storage facility, after the produce is placed in the storage facility, or both before and after the produce is placed in the storage facility. The fumigation process may be employed once or may be repeated as required. In a preferred use, the 1-octen-3-ol, 3-octanone, isoamyl formate, or mixture thereof is applied by controlled release from a dispenser.

The present invention also provides a method of controlling nematodes, comprising applying an effective amount of 1-octen-3-ol, 3-octanone, isoamyl formate, or a mixture thereof, to an area requiring nematode control. Advantages and preferred features of the method of the present invention are as hereinbefore described in relation to the use of the present invention.

The present invention further provides the use of 1-octen-3-ol, 3-octanone, isoamyl formate, or a mixture thereof, as a nematicide as hereinbefore described to treat surfaces (e.g. surfaces in food storage facilities or potato/fruit washing and preparation areas prior to storage or packaging).

### BRIEF DESCRIPTION OF THE DRAWINGS

These and further aspects of the invention will now be further described, by way of example only, with reference to the accompanying figures in which:

FIG. 1 is a schematic diagram showing the experimental set up used in the studies described in the Examples below. FIG. 1A is a cross-section of the experimental arena; FIG. 1B is a plan view of the sealed arena, indicating the circles (central, inner and outer) used for the transect (solid line) and a visual representation of the expected VOC concentration gradient (dashed lines);

FIG. 2 is a series of graphs showing the percentage mortality of EPNs exposed to VOCs at 5, 10, 15 and 20 μl, 3 hours post treatment. 0 μl results are the results for the control group (no VOC). Boxes denote interquartile range, bisected horizontally by median values; whiskers extend to 1.5×interquartile range beyond boxes; outliers are marked as dots beyond whiskers. The graph marked a) (top row, left hand side) shows the results for the EPN S. feltiae (Sf) treated with 3-octanone. The graph marked b) (top row, middle) shows the results for Sf treated with 1-octen-3-ol. The graph marked c) (top row, right hand side) shows the results for Sf treated with 1-octene. The graph marked e) (middle row, left hand side) shows the results for the EPN H. bacteriophora (Hb) treated with 3-octanone. The graph marked f) (middle row, middle) shows the results for Hb treated with 1-octen-3-ol. The graph marked g) (middle row, right hand side) shows the results for Hb treated with 1-octene. The graph marked i) (bottom row, left hand side) shows the results for the EPN S. carpocapsae (Sc), treated with 3-octanone. The graph marked j) (bottom row, middle) shows the results for Sc treated with 1-octen-3-ol. The graph marked k) (bottom row, right hand side) shows the results for Sc treated with 1-octene;

FIG. 3 is a series of graphs showing the percentage mortality of EPNs exposed to VOCs at 5, 10, 15 and 20 μl, 6 hours post treatment. 0 μl results are the results for the control group (no VOC). Boxes denote interquartile range, bisected horizontally by median values; whiskers extend to 1.5×interquartile range beyond boxes; outliers are marked as dots beyond whiskers. The ordering of the graphs, and the EPN/VOC combinations the results of which are depicted in the graphs, are as described for FIG. 2 above;

FIG. 4 is a series of graphs showing the percentage mortality of EPNs exposed to VOCs at 5, 10, 15 and 20 μl, 12 hours post treatment. 0 μl results are the results for the control group (no VOC). Boxes denote interquartile range, bisected horizontally by median values; whiskers extend to 1.5×interquartile range beyond boxes; outliers are marked as dots beyond whiskers. The ordering of the graphs, and the EPN/VOC combinations the results of which are depicted in the graphs, are as described for FIG. 2 above;

FIG. 5 is a series of graphs showing the percentage mortality of EPNs exposed to VOCs at 5, 10, 15 and 20 μl, 24 hours post treatment. 0 μl results are the results for the control group (no VOC). Boxes denote interquartile range, bisected horizontally by median values; whiskers extend to 1.5×interquartile range beyond boxes; outliers are marked as dots beyond whiskers. The ordering of the graphs, and the EPN/VOC combinations the results of which are depicted in the graphs, are as described for FIG. 2 above;

FIG. 6 is a series of graphs showing the percentage mortality of the root knot nematode M. hapla exposed to VOCs at 5 and 10 μl, 3, 6 and 24 hours post treatment. 0 μl results are the results for the control group (no VOC). Boxes denote interquartile range, bisected horizontally by median values; whiskers extend to 1.5×interquartile range beyond boxes; outliers are marked as dots beyond whiskers. The graph marked a) (top row, left hand side) shows the results for M. hapla treated with 3-octanone 3 hours post treatment. The graph marked b) (top row, middle) shows the results for M. hapla treated with 3-octanone 6 hours post treatment. The graph marked c) (top row, right hand side) shows the results for M. hapla treated with 3-octanone 24 hours post treatment. The graph marked d) (bottom row, left hand side) shows the results for M. hapla treated with 1-octen-3-ol 3 hours post treatment. The graph marked e) (bottom row, middle) shows the results for M. hapla treated with 1-octen-3-ol 6 hours post treatment. The graph marked f) (bottom row, right hand side) shows the results for M. hapla treated with 1-octen-3-ol 24 hours post treatment.

FIG. 7a shows the decrease in adult and juvenile population of parasitic plant nematodes versus the concentration of a composition comprising 1-octen-3-ol and microcrystalline cellulose. The % decrease in concentration was measured one day (blue bar) and five days (orange bars) post treatment in the top (A), middle (B) and bottom (C) layers of soil.

FIG. 7b shows the decrease in eggs from parasitic plant nematodes versus the concentration of a composition comprising 1-octen-3-ol and microcrystalline cellulose. The % decrease in concentration was measured one day (blue bar) and five days (orange bars) post treatment in the top (A), middle (B) and bottom (C) layers of soil.

### EXAMPLES

### Analysis Methods

All statistical analyses were carried out using RStudio statistics package (RStudio, Inc. version 1.0.153), using “MASS” and “multcomp” packages. For all mortality data, differential sensitivity between EPN species and/or insect species and differential compound potency were determined using a generalised linear model (GLM) and Tukey's range test in post-hoc analysis. LD₅₀ values were calculated using a GLM and the “dose.p” function within the “MASS” package. An ANOVA was carried out on the chemotactic responses of EPNs to VOCs, with the strength of response compared at each time and concentration. Welch's t-tests were used to compare means of mortality results in the final EPNs efficacy assay.

Extraction of VOCs from Metarhizium brunneum Metarhizium brunneum isolates V275 (Origin: Cydia pomonella, Austria) were maintained on Sabouraud Dextrose Agar, pH 5.6 (SDA) and the conidia from these cultures used in subsequent studies. VOCs were collected from M. brunneum cultures produced on several substrates including: (1) Osmotic Stress Medium (OSM, 8% glucose, 2% peptone, 5.5% agar, 5.5% KCl), (2) High C:N (75:1) medium (HCN, 9.1% glucose, 1% peptone, 2% agar), (3) Intermediate C:N (35:1) medium (ICN, 4% glucose, 1% peptone, 2% agar), and (4) low C:N (10:1) medium (LCN, 0.6% glucose, 1% peptone, 2% agar). VOCs were collected at two time points: 7 days and 14 days post-inoculation, which correspond with the mycelial and sporulating stages of the fungus. All media were obtained from Sigma Aldrich (Poole, UK) except peptone, which was obtained from Oxoid Ltd. Cultures were produced on 10 ml medium in 25 ml glass vials incubated in the dark at 25° C. There were three replicates per treatment (isolate, culture medium) with the whole experiment being repeated twice.

Headspace VOCs were collected from the above treatments using a 50/30 mm Divinylbenzene/Carboxen/Polydimethylsiloxane (DVB/CAR/PDMS) solid phase microextraction (SPME) fibre (Supelco, Bellefonte, Pa., USA) and analyzed using an Agilent 6890N Gas Chromatograph equipped with an HP-5MS fused capillary column (30 m×0.25 mm×0.25 μm film thickness), interfaced directly with an Agilent 5975 mass spectrometer. Helium was used as the carrier gas with a constant flow of 1.0 ml/min. Immediately after collection of VOCs, the SPME needle was inserted manually into the injection port (230° C.; splitless mode) of the GC-MS for thermal desorption and held for 2 minutes. After desorption, the oven was held at 40° C. for 2 min, then the temperature raised to 200° C. at a rate of 3° C./min. Finally, the temperature was raised to 270° C. at a rate of 8° C./min and held at 270° C. for 10 min. Mass spectra were scanned repeatedly over 35-650 amu. Ionization was performed in electron impact (EI) mode at 70 eV. A blank run was performed after each analysis in order to confirm that no residual compound was polluting the fibre or column. Total ion current (TIC) chromatograms were integrated without any correction for co-elution and results were expressed as percent of the total peak area. All peaks were identified from their mass spectra by comparison with spectra in Wiley Registry (9^{th} edition) and NIST11 (National Institute of Standards and Technology, Gaithersburg, Md., USA) libraries. Identifications were confirmed by comparing the retention time (R₁), molecular ions, and fragmentation pattern with authentic standard samples. The peaks observed in the control (blank media without fungus) were excluded from the samples during the sample analysis. All reference compounds used for identification were purchased from Sigma Aldrich (Poole, UK).

The results are shown in Table 1 below.

TABLE 1
VOCs produced by M. brunneum V275 on different substrates. The values are percentage values and are
proportional to the compound with the highest peak (100%) in the chromatogram. Values are means of 5
replicates. — indicates the VOC was not observed. Tr. indicates a trace amount of the VOC was observed.

| | | | V275 (After 7 days) | | | | V275 (After 14 days) | | | |
|---|---|---|---|---|---|---|---|---|---|---|
| Compound | Rₜ (min) | MW | OSM | HCN | ICN | LCN | OSM | HCN | ICN | LCN |
| Ethyl acetate | | 88 | — | 43.04 | 37.95 | 16.42 | — | — | — | — |
| Acetic acid | | 60 | 100 | 85.76 | — | — | — | — | — | — |
| 3-hydroxy-2-butanone | 2.015 | 88 | — | 49.38 | 33.58 | 32.25 | — | 57.9 | 73.73 | 100 |
| Isoamyl alcohol | 2.075 | 88 | 2.30 | 20.44 | 100 | 100 | — | — | — | — |
| Isoamyl formate | 2.770 | 116 | — | — | 4.88 | — | — | — | — | — |
| Methyl isovalerate | 2.945 | 116 | — | — | 2.01 | — | — | — | — | — |
| 1-Octene | 3.520 | 112 | — | — | — | — | 11.13 | 2.67 | 10.02 | 3.89 |
| 2,3-butanediol | 4.168 | 90 | — | Tr. | Tr. | — | — | 43.43 | 44.49 | 4.16 |
| (R or S isomer) | | | | | | | | | | |
| 2,3-butanediol | 4.479 | 90 | — | 100 | 65.96 | — | — | 100 | 100 | 19.48 |
| (R or S isomer) | | | | | | | | | | |
| 1,3-Octadiene | 4.662 | 110 | — | — | — | — | 56.20 | 14.92 | 88.05 | 34.14 |
| Isovaleric acid | 4.667 | 102 | 8.46 | 20.40 | — | — | — | — | — | — |
| Isopentyl acetate | 4.708 | 130 | — | 10.05 | 9.40 | 7.5 | — | — | — | — |
| 1-Octene-3-ol | 7.099 | 128 | — | — | — | — | 100 | 12.39 | 32.89 | 18.03 |
| (R,S isomer) | | | | | | | | | | |
| 3-Octanone | 7.101 | 128 | — | — | — | — | — | — | — | 20.53 |
| Methyl 2- | 11.636 | 158 | 8.40 | 11.1 | 12.93 | 29.68 | — | 1.79 | 1.40 | 5.85 |
| ethylhexanoate | | | | | | | | | | |
| Methyl 3-hydroxy | 11.869 | 158 | — | — | — | 5.87 | — | — | — | — |
| cyclopentyl acetate | | | | | | | | | | |
| 1-Undecene | 14.090 | 154 | — | — | 9.28 | 56.61 | — | — | 3.66 | 19.25 |
| 2-Phenylethanol | 15.780 | 122 | — | — | 6.52 | — | — | — | — | — |
| Cedrene | 16.454 | 204 | 14.2 | Tr. | — | 4.85 | 17.64 | 9.30 | 5.53 | 13.20 |

The results show that isoamyl formate, 1-octene-3-ol and 3-octanone are all produced by the V275 strain of M. brunneum on different agar media.

The VOCs used in the examples below were purchased from Sigma Aldrich.

### Maintenance of Test Entomopathogenic Nematode (EPN) and Insects

Third instar infective juveniles (IJs) of the EPN Steinernema carpocapsae, S. feltiae and Heterorhabditis bacteriophora were kindly provided by BASF Ltd. (UK). The EPNs were stored at 4° C. until required. At least >90% viability was determined for the control in all the experiments. Nematodes that did not move even after prodding were considered dead. Late instar larvae of G. mellonella and yellow mealworm beetle (T. molitor) were obtained from Livefood UK Ltd. (Somerset, UK). Both were reared in 0.7 L glass jars at 28° C., 50-60% RH with a 12:12 light:dark cycle. Mealworm were fed bran while wax moth larvae were provided an artificial diet composed of 22.5% corn meal, 12.5% honey, 12.5% glycerol, 12.5% beeswax, 10% wheat flour, 12.5% milk solids, 5% yeast and 12.5% distilled water.

EPNs were used in Examples 1 and 2 because they were readily obtainable. It is expected that plant parasitic nematodes are at least as susceptible to the VOCs as the EPNs tested.

### Example 1: Screening of 12 VOCs for Nematicidal Activity

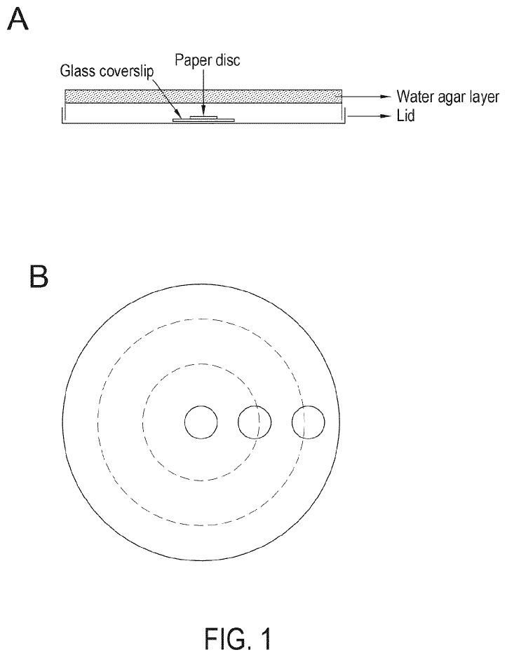

Authenticated M. brunneum VOCs, along with other selected VOCs, were screened for nematicidal activity against S. feltiae and H. bacteriophora. 750 μl of nematode suspension containing approximately 5000 Us in tap water, was spread uniformly over the water agar surface (2.6% w/v agar, 5 mM potassium phosphate pH 6, 1 mM CaCl₂ and 1 mM MgSO₄) of a Petri dish. Each Petri dish (90 mm) contained 20 ml of the water agar medium. The inoculated plates were kept in darkness for 3 hr at room temperature to acclimatize. The plates were then exposed to 20 μl of the VOC dispensed from a 8 mm paper disc (Whatman™, 0.34 mm thickness) positioned on a 25×25 mm glass coverslip placed in the centre of the Petri dish lid (FIG. 1A). The plates were sealed with a double layer of Parafilm and were kept in the dark at 21° C. and checked after 24 hr. The number of live and dead nematodes were counted with the aid of a stereo binocular microscope (30×).

The transect (FIG. 1B) allowed for recording of dead, debilitated and live EPN whose distribution correlated with VOC deposition. The deposition was predetermined using bacterial cultures highly sensitive to these VOCs. The edge of the circular zone of inhibition delineated the area of activity. The highest concentration of the VOC was in the centre (immediately beneath loaded filter paper) then gradually decreased to low levels at the outer zone. As a result, a transect was used to take into account any differences in compound concentration within the agar.

Mean of mortality was calculated from the total number of alive and dead individuals across all circles. There were five replicates per treatment and the whole experiment was repeated twice. The results are shown in Table 2 below.

TABLE 2
Screening of M. brunneum VOCs for nematicidal
activities against two EPN species.

Mortality (%) (Mean ± SE)

| Compound (purity) | S. feltiae (Sf) | H. bacteriophora (Hb) |
|---|---|---|
| Isoamyl alcohol (99%) | 20.8 ± 3 | 9.7 ± 2.1 |
| Isoamyl formate (95%) | 58 ± 2.2 | 46.6 ± 1.8 |
| Methyl isovalerate (98%) | 38.1 ± 7 | 55 ± 2.6 |
| 3-Octanone (98%) | 100 ± 0 | 100 ± 0 |
| (R)-(+)-Limonene (97%) | 16.7 ± 3.2 | 5.9 ± 1.9 |
| Isovaleric acid (99%) | 16.1 ± 3.8 | 13 ± 2.8 |
| 1-Octene-3-ol (98%) | 100 ± 0 | 91.6 ± 2.1 |
| Farnesene | 43 ± 1.1 | 7.8 ± 3.1 |
| (mixture of isomers) | | |
| 2,3-Butanediol (98%) | 12.5 ± 7.2 | 11.4 ± 2.3 |
| 1-Octene (98%) | 20.1 ± 3 | 19.4 ± 3.8 |
| Undecane (99%) | 25.4 ± 5.6 | 7.5 ± 2.7 |
| Tridecane (99%) | 32.3 ± 5 | 4.1 ± 1.6 |
| Control (EPN only) | 7.5 ± 0.8 | 7.9 ± 0.9 |

Of the 12 compounds tested, the M. brunneum VOCs 3-octanone and 1-octen-3-ol were highly toxic, causing 85-100% mortality (Table 2). 3-octanone caused 100% mortality in both EPN species while the M. brunneum VOC 1-octen-3-ol caused 100% and 91.6±2.1% mortality of S. feltiae and H. bacteriophora, respectively (Table 2). Isoamyl formate caused 58% and 46.6±1.8 mortality of S. feltiae and H. bacteriophora, respectively (Table 2).

### Example 2: Dose Mortality Assay for the EPNs

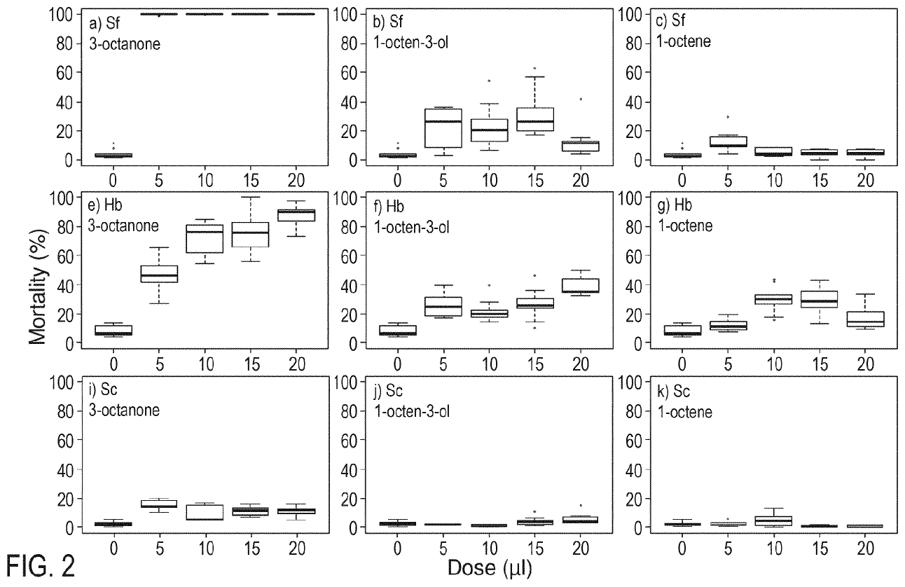

Dose mortality assays were performed using 3-octanone and 1-octen-3-ol. The assays were performed as described in Example 1, except that the EPNs (S. carpocapsae (Sc), S. feltiae (Sf) and H. bacteriophora (Hb)) were exposed to different doses of the VOCs (5, 10, 15 and 20 μl). The mortality was recorded as described previously at 3, 6, 12 and 24 hr post treatment. Controls included EPNs only (no VOC) and EPNs+1-octene. The results are shown in FIG. 2 (results 3 hr post treatment), 3 (results 6 hr post treatment), 4 (results 12 hr post treatment) & 5 (results 24 hr post treatment).

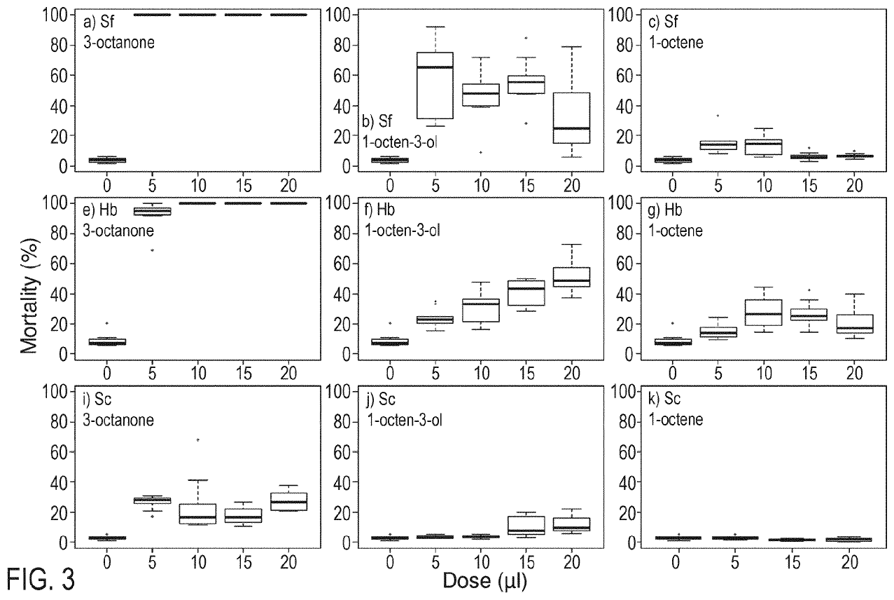

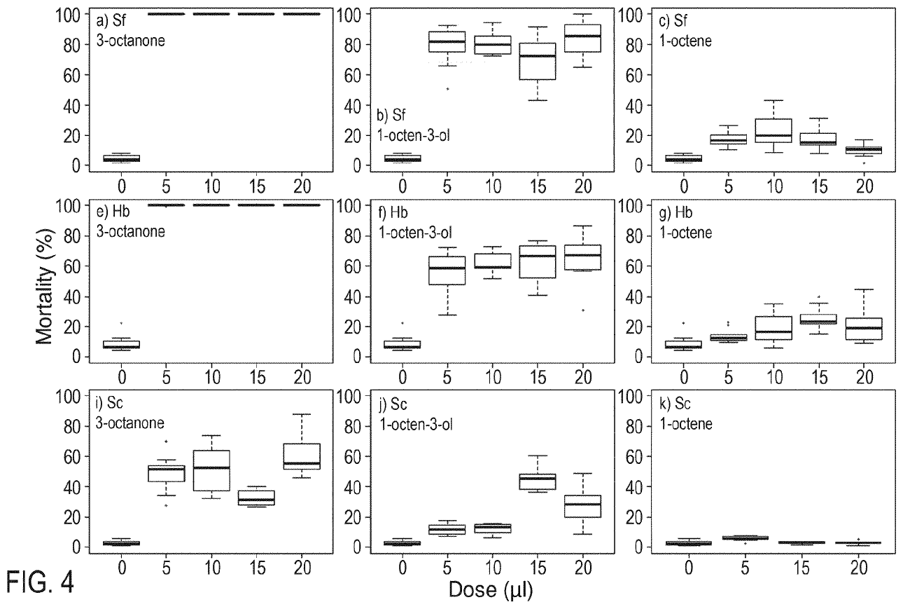

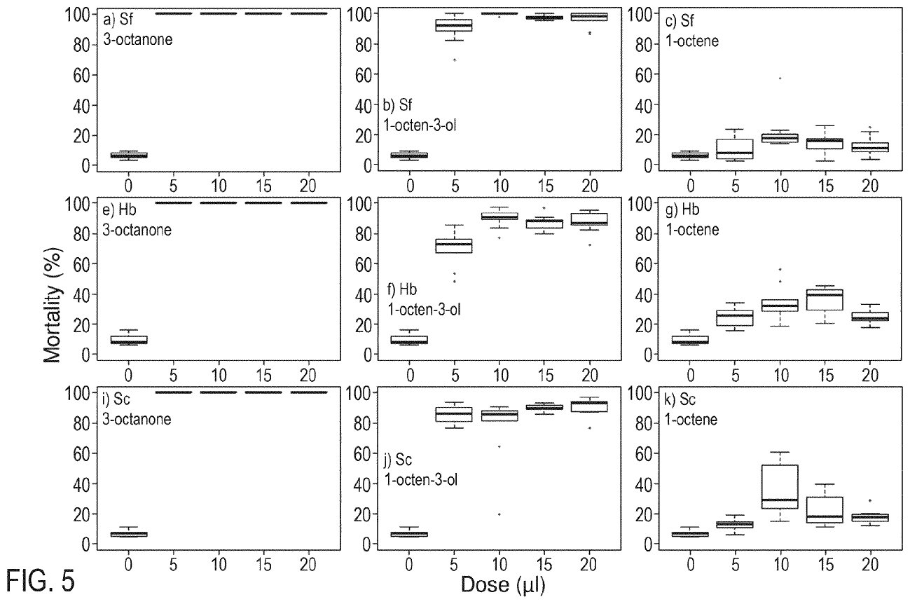

The EPNs exhibited somewhat differential sensitivity to the nematicidal compounds at shorter exposure times (FIG. 2, FIG. 3). For example, following 6 hr exposure time S. feltiae was most sensitive, with S. carpocapsae being the most tolerant (FIG. 3). However, mortality was very high for all three EPNs exposed to 3-octanone or 1-octen-3-ol after 24 hr (FIG. 5). By contrast, mortalities for the EPNs exposed to 1-octene were extremely low and remained low over time.

It was observed that the mortality was generally higher in the centre of the Petri dish and decreased with the distance from the centre.

For each species, an LD₅₀ value was calculated at the most appropriate time point. The results are set out in Table 3 below.

TABLE 3
A summary of the LD₅₀ values for the three nematode species
exposed to each compound after an appropriate time period
(±SE). Where a = >99% mortality from 3 hr and b =
mortality too low across all time periods to calculate an accurate
LD₅₀, therefore no nematicidal effect assumed.

| Species | Compound | Time (hr) | LD₅₀ (μl) | (±SE) |
|---|---|---|---|---|
| S. carpocapsae | 1-octen-3-ol | 24 | 41.01 | 1.06 |
| S. feltiae | | 6 | 10.56 | 1.04 |
| H. bacteriophora | | 6 | 21.72 | 1.05 |
| S. carpocapsae | 3-octanone | 12 | 94.88 | 8.27 |
| S. feltiae | | a | a | a |
| H. bacteriophora | | 3 | 5.68 | 1.03 |
| S. carpocapsae | 1-octene | b | b | b |
| S. feltiae | | b | b | b |
| H. bacteriophora | | b | b | b |

LD₅₀ values could not be obtained for EPN exposed to 1-octene because the mortality was too low or for S. feltiae exposed to 3-octanone because mortality was >99% at all time points. The LD₅₀ of 3-octanone against H. bacteriophora was 5.68 μl±1.03 after 3 hr, but could not be calculated at later time points because the mortality exceeded 90%. The LD₅₀ of H. bacteriophora exposed to 1-octen-3-ol was 21.72 μl±1.05 after 6 hr. For S. carpocapsae, the LD₅₀ values of 3-octanone and 1-octen-3-ol were 94.88 μl±8.27 after 12 hr and 41.01 μl±1.06 after 24 hr, respectively. The LD₅₀ values could not be calculated for S. carpocapsae exposed to 3-octanone after 24 hr because all nematodes were dead at all doses. For 1-octene, both Steinernema species showed low mortality with no statistical difference (Est.=−0.33, s.e.=0.43, z=−0.76, p<0.721). However, after 24 hr, the mortality was slightly higher for both species, but did not exceed 50% with no significant difference found between EPN species.

### Example 3: Susceptibility of Meloidogyne hapla to VOCs

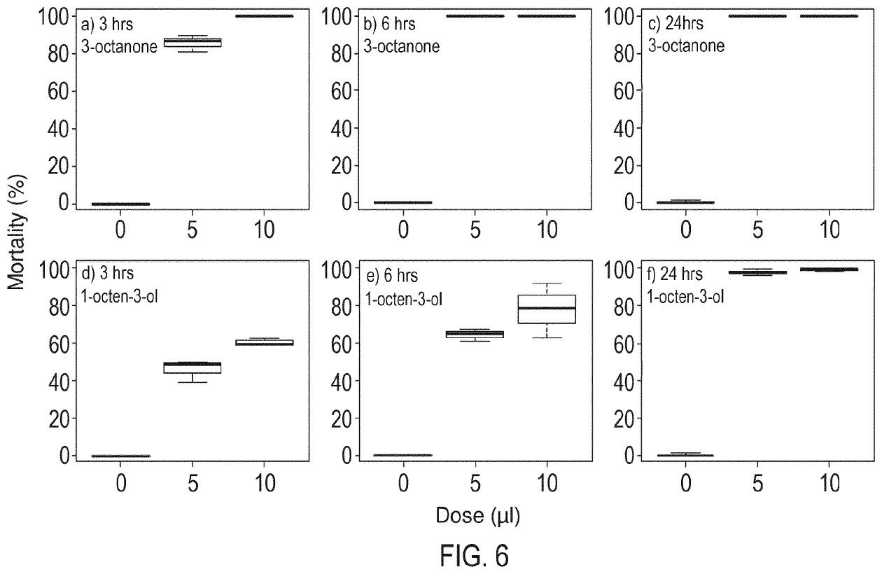

A study was conducted to determine the susceptibility of the root knot nematode M. hapla, a major crop pest, to 3-octanone and 1-octen-3-ol. Single egg-mass populations of M. hapla were kindly provided by Dr Ivan Grove (Harper Adams University/Crop and Environment Sciences). Four-week-old tomato plants (Solanum lycopersicum cv. Rutgers) were grown in a greenhouse. Soil in each pot was infested by pipetting egg masses of M. hapla suspended in tap water and cultivated at approximately 25±2° C. in a greenhouse. Six months following inoculation, tomato plants were uprooted and root systems were carefully washed with running tap water to remove adhered soil. The roots were cut into small pieces and extracted by the Baermann funnel method for 3-5 days to obtain live nematodes. The inoculum concentration included a range of life stages and was adjusted to approximately 2000 individuals using tap water by the aid of a haemocytometer. A mortality assay was carried out as described in Examples 1 and 2 above. The assay was carried out at two doses of the VOCs (5 μl and 10 μl) and the mortality was recorded at 3, 6 and 24 hr post treatment. There were three replicates per treatment and the whole experiment was repeated twice. The results are shown in FIG. 6.

Both 3-octanone and 1-octen-3-ol showed strong nematicidal activity against M. hapla. 3-octanone caused 100% mortality exposed to 10 μl and 5 μl within 3 hr and 6 hr, respectively. 1-octen-3-ol exhibited a dose dependent response after 3 hr and 6 hr. When the nematodes were examined after 24 hr, over 90% were dead at both doses. The control showed no mortality at 3 hr and 6 hr and less than 2% at 24 hr.

### Example 4: Nematicidal Effect of VOC Formulation

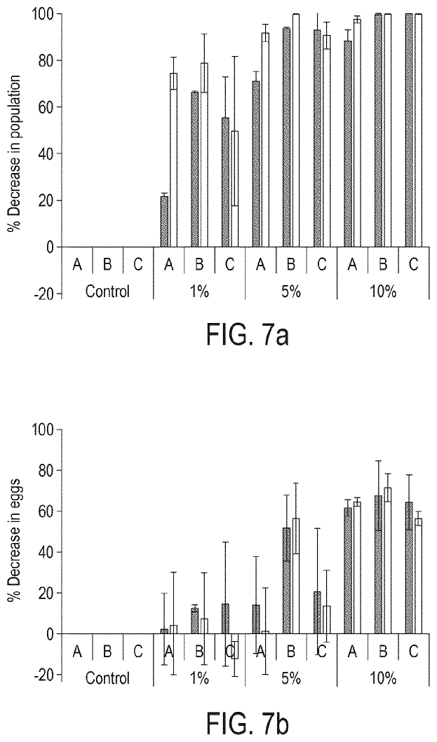

1-octen-3-ol (5% v/w) was mixed with microcrystalline cellulose and the wettable powder was mixed into soil containing a plant parasitic nematode at different concentrations (1, 5 and 10% w/w). The % decline in the population of adult and juveniles as well as eggs was recorded one day (black bars) and five days (grey bars) post treatment in the top (A), middle (B) and bottom (C) layers of soil. The results are shown in FIGS. 7a and 7b.

It can be seen from FIGS. 7a and 7b that the presence of the composition comprising 1-octen-3-ol and microcrystalline cellulose significantly decreases both the amount of adult and juvenile parasitic nematodes as well as the number of eggs. The compositions comprising a higher amount of 1-octen-3-ol generally achieved a higher level of decrease, i.e. achieved a higher level of mortality. The level of decrease measured was also generally higher at 5 days compared to 1 day showing that the nematodes were killed.

1. Use of 3-octanone, 1-octen-3-ol, isoamyl formate, or a mixture thereof, as a nematicide.

2. The use according to claim 1, wherein 1-octen-3-ol is the nematicide.

3. The use according to claim 1, wherein 3-octanone is the nematicide.

4. The use according to claim 1, wherein isoamyl formate is the nematicide.

5. The use according to claim 1, wherein said 1-octen-3-ol, 3-octanone isoamyl formate, or mixture thereof is used separately, sequentially and/or in combination with a further pesticide.

6. The use according to claim 5, wherein said further pesticide is a further nematicide.

7. The use according to claim 6, wherein said further nematicide is selected from methyl bromide, 1,3-dichloropropene, ethylene dibromide, metam-sodium, dazomet, methyl isothiocyanate, chloropicrin, thionazin, ethoprophos, fenamiphos, fensulfothion, terbufos, isazofos, ebufos, aldicarb, aldoxycarb, oxamyl, carbofuran, cleothocarb and mixtures thereof.

8. The use according to claim 1, wherein said 1-octen-3-ol, 3-octanone, isoamyl formate, or mixture thereof is used in the form of a composition, and said composition comprises one or more additional ingredients.

9. The use according to claim 8, wherein said composition is a solid composition.

10. The use according to claim 9, wherein said sold composition is in the form of pellets, granules (e.g. emulsifiable granules, water dispersible granules or granules for broadcast application), powders (e.g. wettable powders, soluble powders), briquettes, blocks, dusts or mixtures thereof.

11. The use according to claim 8, wherein said composition is a liquid composition.

12. The use according to claim 8, wherein said composition is a slurry composition.

13. The use according to claim 12, wherein said slurry composition is applied to seeds.

14. The use according to claim 1, wherein said 1-octen-3-ol, 3-octanone, isoamyl formate, or mixture thereof is a nematicide in a fumigant.

15. The use according to claim 1 to control plant parasitic nematodes.

16. (canceled)

17. The use according to claim 1 to treat soil, seeds, bulbs, crops, tubers, trees, stored produce or timber.

18-23. (canceled)

24. The use according to claim 1, wherein said 1-octen-3-ol, 3-octanone, isoamyl formate, or mixture thereof is applied to an area to be treated by band application, basal application, broadcast application, crack and crevice application, directed-spray application, foliar application, soil application, soil incorporation, soil injection, rope-wick treatment, wiper treatment, space treatment, spot treatment, tree injection, spraying and/or fumigation.

25. The use according to claim 1 as a nematicide in a fumigation process.

26. A method of controlling nematodes, comprising applying an effective amount of 3-octanone, 1-octen-3-ol, isoamyl formate, or a mixture thereof, to an area requiring nematode control.
